(19) United States
(12) Patent Application Publication
(10) Pub. No.: US 2021/0107124 A1
(43) Pub. Date: Apr. 15, 2021

(54) COUPLER AND REMOVAL TOOL FOR SAME

(71) Applicant: ASAHI YUKIZAI CORPORATION, Miyazaki (JP)

(72) Inventor: Hideaki IGUCHI, Miyazaki (JP)

(21) Appl. No.: 16/753,584

(22) PCT Filed: Oct. 3, 2018
(86) PCT No.: PCT/JP2018/036963

§ 371 Date: Dec. 10, 2020

(30) Foreign Application Priority Data
Oct. 4, 2017 (JP) 2017-193990

(51) Int. Cl. B25B 27/14; F16K 27/00

(52) U.S. Cl. CPC B25B 27/14; F16K 27/00

(57) ABSTRACT

Provided are a coupler that can be produced at a low cost and that enables an actuator and a valve to be easily attached and detached without using a fastener, and a removal tool for the same. According to a coupler (3) for an actuator (4) and a valve (2), which is sandwiched detachably between the actuator (4) and the valve (2), the valve (2) is provided with a flange portion (22) protruding from an outer periphery of a valve main body, and the coupler (3) is provided with an elastically deformable hook portion (31) latching onto an outer periphery of the flange portion (22) to prevent detachment of the coupler (3), and a fixing portion (35) fastened to the actuator (4).

### TECHNICAL FIELD

The present invention relates to a coupler for an actuator and a valve, and a removal tool for the same, and more particularly to a coupler that enables an actuator to be easily attached to and detached from a valve, and a removal tool for the same.

### BACKGROUND ART

Hitherto, a valve is installed in a pipe, and the flow of a fluid is controlled by opening and closing the valve.

The drive unit for opening and closing the valve is called an actuator, and various types of actuation such as a pneumatic type, an electric type, a hydraulic type, and a solenoid type are used.

A valve with an actuator, in which such an actuator is connected, is configured such that the actuator and the valve are made attachable to and detachable from each other from the viewpoint of maintenance and inspection. Proposed in Patent Document 1, for example, is a valve with an actuator in which a bolt is provided in a horizontal position to enable easy tightening of the bolt. Further, proposed in Patent Document 2, for example, is a valve with an actuator configured to be attachable and detachable by using a spring clip. In addition, proposed in Patent Document 3 is a valve with an actuator configured to sandwich the valve by a bracket having a curved stirrup.

### CITATION LIST

### Patent Documents

Patent Document 1: U.S. Pat. No. 4,633,897
Patent Document 2: U.S. Pat. No. 8,632,054
Patent Document 3: U.S. Pat. No. 6,848,672

### SUMMARY OF THE INVENTION

### Problems to be Solved by the Invention

However, the patent documents and the like presented above show room that still remains to be improved. The valve with an actuator disclosed in Patent Document 1 has been posing a problem in that the actuator and the valve are detachably fixed using a fastener such as a bolt, thus requiring a work space for unfastening when replacing the actuator. In the first place, pipes are frequently arranged to save space, and a plurality of pipes having different diameters are arranged around a single pipe. Therefore, the working space around the piping is limited, and it is extremely difficult to unfasten the actuator and the valve by using an existing fastener in such a place.

The valve with an actuator disclosed in Patent Document 2 has been posing a problem in that the use of a curved spring pin results in a complicated structure and a high manufacturing cost.

The valve with an actuator disclosed in Patent Document 3 is configured to clamp the valve with the curved stirrup, so that the stirrup has fallen off in some cases due to a vibration caused by a pressure change of a fluid in a pipe.

The present invention has been made with a view of solving the problems with the prior arts described above, and it is an object of the invention to provide a coupler which does not use a fastener, which reduces manufacturing cost, and which enables an actuator and a valve to be easily attached and detached, and a removal tool for the same.

### Means for Solving the Problems

To this end, a coupler in accordance with the present invention is a coupler for an actuator and a valve which is detachably sandwiched between an actuator and a valve. As a first characteristic, the valve has a flange portion that projects from the outer periphery of a valve main body, and the coupler has an elastically deformable hook portion that latches onto the outer periphery of the flange portion thereby to prevent the coupler from detaching, and a fixing portion fastened to the actuator.

Further, as a second characteristic, the flange portion has at least one notched portion, and the coupler has at least one guide portion which is fitted along the notched portion.

Further, a removal tool for a coupler in accordance with the present invention is a removal tool which causes the hook portion to be elastically deformed by utilizing the principle of leverage thereby to be released from the flange portion. As a first characteristic, the removal tool includes a gripping piece and a releasing piece extended from the gripping piece, and the distal end side of the releasing piece is curved in the direction in which the hook portion is elastically deformed, and has a stepped portion formed to be in contact with only the hook portion.

Further, a second characteristic is that the removal tool further includes a finger hook piece.

### Advantageous Effect of the Invention

The present invention has the following excellent effects.
(1) The connector to which the actuator is to be fixed is engaged with the flange portion of the valve by the elastically deformable hook portion that latches onto the outer surface of the flange portion, so that the actuator can be connected to the valve with a single touch and the actuator can be easily detached from the valve simply by disengaging the hook portion. Hence, the attaching and detaching operation is easily performed in a small work space, and the attaching and detaching time can be shortened. Further, the actuator alone can be separated and replaced by releasing the engagement between the actuator and the fixing portion of the coupler.
(2) The coupler has the guide portion which is to be fitted to the notched portion provided in the flange portion of the valve, thus making it possible to prevent the coupler and the actuator from rotating with respect to the valve.
(3) By using the dedicated removal tool, the hook portion can be elastically deformed with ease to detach the coupler from the valve. Further, as compared with the case where an existing tool such as a flat-bladed screwdriver is used, damage to a plastic valve or coupler caused by scratching or the like can be prevented.

### BRIEF DESCRIPTION OF THE DRAWINGS

FIG. 1 is an exploded perspective view illustrating an embodiment of a coupler for an actuator and a valve in accordance with the present invention;

FIG. 2(a) is a perspective view of the coupler in FIG. 1 observed in a plane direction, and FIG. 2(b) is a perspective view thereof observed in a bottom direction; and

FIG. 3 presents the longitudinal sectional views for explaining a removal tool in accordance with the present invention.

### MODE FOR CARRYING OUT THE INVENTION

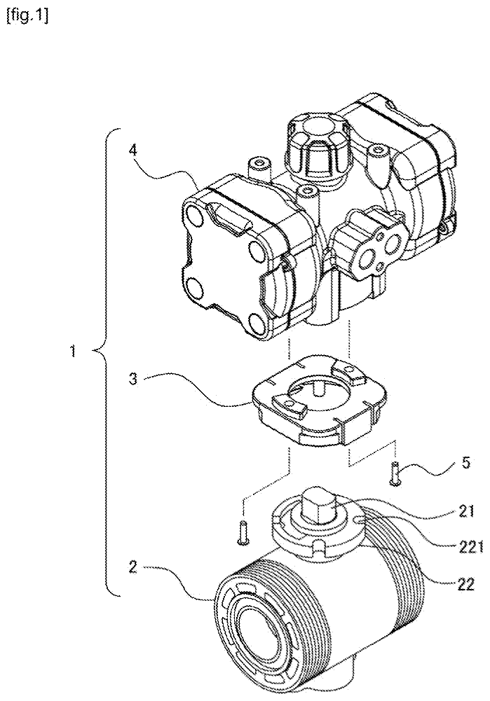

The following will describe an embodiment of the present invention with reference to the drawings that illustrate an example; however, it goes without saying that the present invention is not limited to the example. FIG. 1 is an exploded perspective view of an air ball valve 1 according to an embodiment of the present invention.

The air ball valve 1 is composed of a valve main body 2 to be connected to a pipe, and a coupler 3 to be connected, together with a fixedly provided actuator 4, to the valve main body 2 with a single touch.

The valve main body 2 is a ball valve in the present example. A valve stem 21 is protrusively provided on the top of the valve main body 2, and a disc-shaped flange portion 22 is provided on the upper end of the valve main body 2. The side circumference of the flange portion 22 is provided with a plurality of notched portions 221, and guide portions 32 are fitted into the notched portions 221.

Although the material of the valve main body 2 is not particularly limited, plastic is preferable, and examples of the plastic used include PTFE, PVDF, polyvinyl chloride (hereinafter referred to as PVC), polyethylene (hereinafter referred to as PE), and polypropylene (hereinafter referred to as PP), and any plastic having physical properties suited for the conditions or environment in which the plastic is to be used can be used.

The actuator 4 incorporates a piston and a shaft, and actuates a valve element in the valve main body 2 through the valve stem 21. In the present example, a pneumatic actuator is adopted; however, the present invention is not limited thereto, and various types of actuators such as an electric actuator can be used.

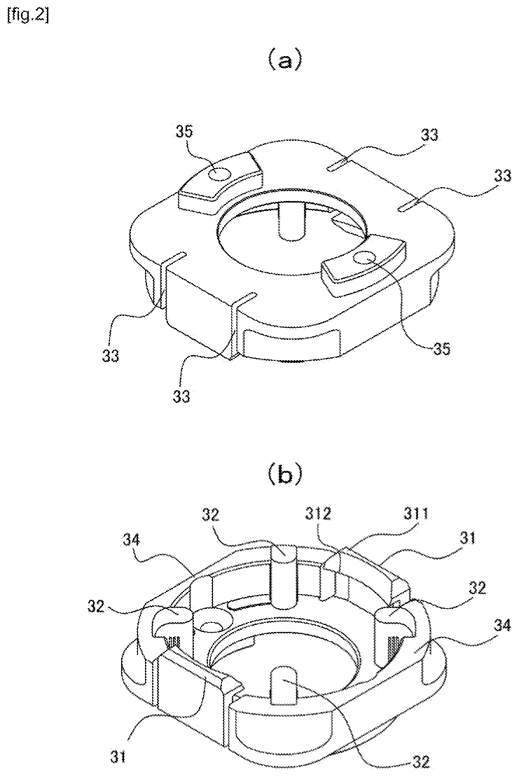

As shown in FIG. 1 and FIG. 2, the coupler 3 is provided with mounting holes 35, and fastening members 5 such as bolts are inserted into the mounting holes 35 and fixed to the actuator 4. The method of fixing the actuator 4 and the coupler 3 is not limited to this, and various fixing methods may be used insofar as a so-called fixing portion is provided. The coupler 3 has a pair of hook portions 31 formed to project downward. This arrangement enables the coupler 3 to be attached to the valve main body 2 by engaging the hook portions 31 with the outer periphery of the flange portion 22 such that the hook portions 31 latch onto the outer periphery of the flange portion 22. Slits 33 are formed on both sides of the hook portions 31, the slits 33 extending from the side surfaces to the upper surface of the coupler 3. With this arrangement, the hook portions 31 are elastically deformed with ease in a direction in which the hook portions 31 latches onto the flange portion 22 or in a direction opposite therefrom, and the hook portions 31 have a large movable range. Hence, the state in which the hook portions 31 are engaged with the flange portion 22 can be released, and the coupler 3 can be therefore detached from the valve main body 2.

As shown in FIG. 2(b), the bottom surface of the coupler 3 is provided with an annular wall 34 having a predetermined height such that the pair of hook portions 31 is a part of the outer periphery, thus providing a predetermined clearance between the actuator 4 and the valve main body 2. The annular wall 34 is provided with a plurality of guide portions 32 projecting inward from the annular wall 34 at positions corresponding to the notched portions 221 described above. This arrangement makes it possible to prevent the coupler 3 and the actuator 4 from rotating with respect to the valve main body 2. Further, toes 312 of the hook portions 31 are formed in an arc shape to match the inner periphery of the annular wall 34, and are configured such that the toes 312 are easily detached from the outer periphery of the flange portion 22.

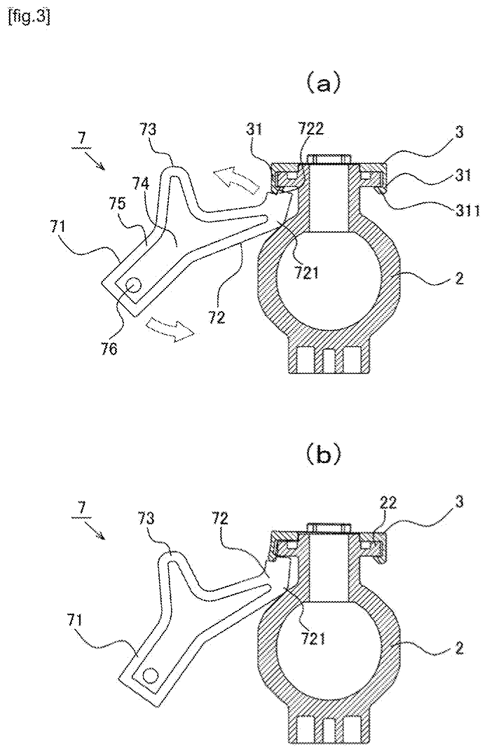

A description will now be given of the removal tool in accordance with the present invention. As illustrated in FIG. 3, a removal tool 7 in accordance with the present invention elastically deforms the hook portions 31 by utilizing the principle of leverage to disengage the hook portions 31 from the flange portion 22. FIG. 3(a) illustrates a state in which the removal tool 7 has been placed on the hook portion 31, and FIG. 3(b) illustrates a state in which the hook portion 31 has been elastically deformed.

The removal tool 7 is a substantially Y-shaped plate provided with a gripping piece 71 that is gripped by an operator, a release piece 72 integrally extended from the gripping piece 71, and a finger hook piece 73 integrally extended from the gripping piece 71. A recessed surface 74 is provided on each of the front surface and the rear surface of the removal tool 7, and a step is provided between a peripheral surface 75 and the recessed surface 74 to enable the operator to set his or her fingertip at the step during an operation. In addition, a through hole 76 is provided so that the operator can move, carrying the removal tool 7 by a string, a chain, or the like attached thereto.

As illustrated in FIG. 3(a), a curved portion 721 is formed at the distal end (the end to be in contact with the valve main body 2) of the release piece 72. The curved portion 721 is curved in a direction that is advantageous for the principle of leverage to work, i.e. a direction for elastically deforming the hook portions 31, so that the curved portion 721 is brought into contact with the valve main body 2 to function as a fulcrum of the principle of leverage, and the distal end of the release piece 72 functions as the operating point of the principle of leverage.

A stepped portion 722 is formed at the distal end of the release piece 72. Hence, the distal end of the release piece 72 securely comes in contact with a top surface 311 of the hook portion 31, thus making it possible to press the hook portion 31 in the direction in which the hook portion 31 is elastically deformed.

With the removal tool 7 configured as described above, the operator can easily detach the toe 312 from the outer periphery of the flange portion 22 by deforming the toe 312, as illustrated in FIG. 3(b), by gripping the gripping piece 71 with one hand, inserting the distal end of the release piece 72 to the bottom of the flange portion 22, bringing the curved portion 721 into contact with the outer surface of the valve main body 2 and also bringing the stepped portion 722 into contact with the top surface 311, which is the distal end of the hook portion 31, and then simply by applying a force in the direction in which the principle of leverage works, with the curved portion 721 being the fulcrum.

The removal tool 7 in accordance with the present invention only needs to include the gripping piece 71 and the release piece 72 as described above, and the key point is to deform the hook portions 31 by utilizing the principle of leverage. It is self-evident that even if the removal tool 7 does not have the finger hook piece 73 and the recessed surface 74, the removal tool 7 functions as a removal tool. However, in terms of workability such as ease of gripping, the provision of the finger hook piece 73 and the recessed surface 74 can impart a variety of gripping methods.

Further, the gist of the coupler in accordance with the present invention is that each of the hook portions 31 provided on the coupler 3 and the flange portion 22 provided on the valve main body 2 can be easily attached and detached with a single touch. Hence, for example, the coupler 3 and the valve main body 2 may be configured to be rotatable with each other without providing the guide portions 32 and the notched portions 221, and the present invention is not limited to the illustrated example. Further, the valve main body 2 is not limited to the illustrated ball valve, and various valves such as a diaphragm valve and a stop valve may be used.

### DESCRIPTION OF REFERENCE NUMERALS

1 air ball valve
2 valve main body
21 valve stem
22 flange portion
221 notched portion
3 coupler
31 hook portion
311 top surface
312 toe
32 guide portion
33 slit
34 annular wall
35 mounting hole (fixing portion)
4 actuator
5 fastening member
7 removal tool
71 gripping piece
72 release piece
721 curved portion
722 stepped portion
73 finger hook piece
74 recessed surface
75 peripheral surface

1. A coupler for an actuator and a valve which is detachably sandwiched between an actuator and a valve, wherein the valve includes a flange portion that projects from an outer periphery of a valve main body, and the coupler includes an elastically deformable hook portion that latches onto an outer periphery of the flange portion thereby to prevent the coupler from detaching, and a fixing portion to be fastened to the actuator.

2. The coupler according to claim 1, wherein the flange portion includes at least one notched portion, and the coupler includes at least one guide portion which is fitted along the notched portion.

3. A removal tool which is used to remove a coupler for an actuator and a valve which is detachably sandwiched between an actuator and a valve, wherein the valve includes a flange portion that projects from an outer periphery of a valve main body, and the coupler includes an elastically deformable hook portion that latches onto an outer periphery of the flange portion thereby to prevent the coupler from detaching, and a fixing portion to be fastened to the actuator, and which causes the hook portion to be elastically deformed by utilizing the principle of leverage thereby to be released from the flange portion,
the removal tool comprising a gripping piece and a releasing piece extended from the gripping piece,
wherein a distal end side of the releasing piece is curved in a direction in which the hook portion is elastically deformed, and has a stepped portion formed to be in contact with the hook portion.

4. The removal tool according to claim 3, further including a finger hook piece.
